(19) United States
(12) Patent Application Publication
(10) Pub. No.: US 2003/0097299 A1
(43) Pub. Date: May 22, 2003

(54) Peer-to-peer (P2P) and internet content digital acknowledgement trigger used for file transfer

(76) Inventors: Robert O'Kane, Palm Beach Gardens, FL (US); Chris Ricci, Cookstown (CA)

Correspondence Address: JEFFREY FURR, 253 N. MAIN STREET, JOHNSTOWN, OH, 43031, US

(21) Appl. No.: 10/002,267

(22) Filed: Nov. 21, 2001

(51) Int. Cl. G06F 17/60; G06F 15/16

(52) U.S. Cl. 705/14; 709/200

(57) ABSTRACT

A system and method is disclosed for information sharing via a peer-to-peer communication network. The system provides for a way to track DIGITAL MEDIA files (a.k.a. video, audio and yet to be determined digital source) over global and through, or hosted on, a local or remote network server. Each download has a unique digital software trigger, or “digital acknowledgement trigger” which is software originated. This trigger is induced by the end user of that particular computer or network related computer or server. Each tag is unique based upon the source IP address and file name requested for download, as well as invisible to the user, and with each user the “software trigger”, or “digital acknowledgement trigger” is activated at the time the Digital File is used or opened without damaging the original file from which the download file was “shared

### CROSS-REFERENCES TO RELATED APPLICATIONS (IF ANY)

Provisional Patent 8C/252.334

### STATEMENT AS TO RIGHTS TO INVENTIONS MADE UNDER FEDERALLY-SPONSORED RESEARCH AND DEVELOPMENT (IF ANY)

None

### BACKGROUND

1. Field of the Invention

This invention relates to the art of transferring data files between users and, more specifically, to the use of peer to peer processing for this purpose.

2. Description of Prior Art

In conventional systems and methods for sharing information, an originator of the information will typically provide the information through an electronic site such as a web site. Users wishing to obtain the information must have available to them, or must download, specific software to their computers or other devices that allows them to access and otherwise use, store, play, or display the information. Representative examples of information typically shared in this manner include, among other things, text, graphical images, sound files, and the like. Once information is obtained by a user, the originator has little (if any) ability to control what the user does with the information. For example, the user subsequently may, in violation of the wishes of the originator, copy the information or disseminate it such that the originator is no longer able to control by whom and when the shared information can be listened to, read, or seen.

A strong need has developed to find a way to track files that are exchanged and used by parties over the Internet and computer regulated networks, websites and exchanges that encourage downloading and exchanging of files that are intellectually protected. Currently, there does not exist a device or process available that reads and tracks where the files flow directly from one computer/user to another, unseen and untouched by any person or company.

These networked technologies, P2P networking, or file sharing networks, allow individual computer users to open their computer related hard drives directly to one another, searching for and swapping files without recourse to more traditional Web databases and servers. Again, there is no method or process available that determines and tracks such file transfers.

In recent years, companies that managed these types of networks, P2P networking, or file sharing networks, allowed people to share music files, video files and just about any other file with no regulatory control. Pure P2P networks, by definition, do not have such technologies or “process” that helps those who own multi-media intellectual rights to track, sell and determine who shares and uses digital media files (a.k.a video, audio, digital art and yet to be determined digital source) and that potential loss of control and security has made it more difficult for entrepreneurs and businesses to devise obvious business models that curb the copyright and security fears.

P2P Audio and Video Networks Work as Follows:

A user/computer “user” asks a “computer or network related computer or server” if an audio/video/digital art file exists on that particular computer or network related computer or server.

Every computer or network server or device which is “hooked” up or hooked into that same particular computer or network related computer or server mentioned in above, responds with a YES or a NO.

Every computer or network server or device which is “hooked” up or hooked into that same particular computer or network related computer or server mentioned in above that answers yes, then hooks up or hooks directly into the user/computer's computer or network related computer or server for download

Or the user receives the file in or through an e-mail message.

Or the user transfers the file on a portable memory card (as used in portable MP3 players)

Or the user uses a wireless enabled device (cellular phone, Personal Digital Assistant etc)

Or the user shares/copies/uploads/modifies the file through any means of electronic communication device(s)

Esther Dyson, chairwoman of the Internet Corporation for Assigned Names and Numbers, wrote in a column in October, 2000, “Peer-to-peer communities need a way to define and identify their members. They need a way to define their own rules and to exclude people who break them.” Business interests are already trying to find answers that will allow for widespread legal P2P commercialization. For example of how P2P networks have had no control, NAPSTER, MP3 and more have all ended up with legal, P2P related suits and the industry has yet to develop a way to track the exchange and or download and illegal use of intellectual properties.

NAPSTER (www.napster.com) and MP3 (www.mp3.com) provides the most illuminating illustration of P2P or file sharing business models/infrastructure. Record companies are seeing their music distributed at unprecedented speeds, but they've lost control of the ability to guide and profit from the system. Any company that hopes to commercialize and stop losing potential business related revenues from peer-to-peer networks must figure out a way to relinquish the right amount of control to its customers without giving away the profitable “commercialization” possibilities.

There is a lot of hard evidence that shows people use P2P type networks and “shared file” networks only because they do not have to pay for all the material they download. Naturally, entities that own respective files that are “shared” will not take millions of people to court. They will, however, shut down the entities that supply a way that files can be exchanged “for free”.

Business and corporate leaders are trying to come up with ways to keep all parties involved within a P2P platform chain happy. They are even trying to arrange for “paid” subscription business models. Most of all, P2P networks offer little regulation or protection of rightful properties inside anonymous networks, which was once a barrier to creating mainstream, integrated business processes.

U.S. Pat. No. 6,183,366 by Goldberg, et al. and issued on Feb. 6, 2001 is for “Network gaming system.” It discloses an information service and advertising providing system for presenting interactive information services together with interactive advertising on a communications network such as the Internet and LANs.

U.S. Pat. No. 6,029,200 by Beckerman, et al. and issued on Feb. 22, 2000 is for an “Automatic protocol rollover in streaming multimedia data delivery system.” It discloses a streaming multimedia rendering system having a network client and a network server that form part of a hyperlink web such as the Internet. In accordance with the invention, a hyperlink to multimedia content is actually an indirect link to a reference file. The reference file contains a plurality of different resource specifiers and a preferred order for attempting communications using the resource specifiers.

U.S. Pat. No. 6,248,946 by Dwek and issued on Jun. 19, 2001 is for a “Multimedia content delivery system and method” It discloses a system and method for delivering multimedia content to computers over a computer network, such as the Internet, and includes a novel media player which may be downloaded onto a user's personal computer. The media player includes a user interface which allows a listener to search an online database of media selections and build a custom playlist of exactly the music selections desired by the listener. The multimedia content delivery system delivers advertisements which remain visible on a user's computer display screen at all times when the application is open; for example, while music selections are being delivered to the user. The advertisements are displayed in a window which always remains on a topmost level of windows on the user's computer display screen, even if the user is executing one or more other programs with the computer.

United States Patent Application 20010037367 by Iyer is a “System and method for sharing information via a virtual shared area in a communication network.” It discloses a system and method for information sharing via a virtual shared area in a communication network. The system includes a virtual shared area having a unique electronic identifier, the shared area being controlled by an owner for permitting access to information in the shared area by multiple users.

United States Patent Application 20010037304 by Paiz is for a “Method of and apparatus for delivery of proprietary audio and visual works to purchaser electronic devices.” The method preferably includes the additional steps of encrypting the works; and provides the end user with program means for deciphering the works. This method preferably includes the additional steps of delivering advertising matter to the end user with each work the end user selects and plays; keeping a record of the particular works each end user selects and plays customizing advertising delivered to the end user to fit within any pattern of work selection by the particular end user.

The need for a method for peer-to-peer file transfers that is secure, quick, profitable, and legal to use shows that there is still room for improvement within the art.

1. Field of the Invention

U.S. Class 720

2. Description of Related Art Including Information Disclosed Under 37 CFR §1.97** > and 1.98<.

### SUMMARY OF THE INVENTION

The object of the present invention is to provide a process that allows intellectual property owners a well defined method to retain and track their properties through P2P (“peer topeer”) or shared file networks that resemble the likes of, NAPSTER, MP3.com, and/or other similar computer file sharing computer networks. Furthermore, it also provides for a method to enforce Digital Millennium Act of 1998.

The current invention process, the digital acknowledgement trigger, when created by software that makes the digital acknowledgement trigger work and activate, creates and defines that process which is needed to regulate the current infrastructure of P2P or file sharing networks, infrastructures or computer systems and computer networks overall, where individuals that are sharing information and content directly can now be tracked and used by way of computer programs that work in tantrum co-inside to regulate and track the actual users. It is a self turning application that is also updated by an “individual” user who updates the software, which includes logic that makes the digital acknowledgement trigger “work and activate”, for centralized development, uniformity and to guarantee the integrity of those same files that are stored and shared on the above mentioned servers and networks.

The digital acknowledgement trigger solves the following problems that currently exist with P2P and file sharing networks:

Entities are Unable to track file downloads

Entities are Unable to protect intellectual downloads and usage.

Entities are Unable to determine the amount of downloads and/or time the file has been “shared”

Entities are Unable to commercialize/profit.

P2P networks and file sharing networks are one of the best ways for businesses or corporations to conserve resources in the way of business development and operational costs. In reality, the consumer loves the “file swapping process” because it's free and communicable between people, colleagues and associates. In short, file-swapping networks are rewriting the distribution revolution for business, entertainment, personal and network computer related file transfers. There is nothing in place to regulate or track it

The current invention will allow a person to send a file once and see it hosted by dozens or even thousands of potential consumers on a network. Those consumers, by offering the file to still others, can wind up subsidizing the storage and bandwidth costs of the original seller by using their own personal computers. The digital acknowledgement trigger creates a method for justifying these subsidizations.

The current invention is geared towards and works with, but is not limited to any of the below file sharing industries:

| | | | |
|---|---|---|---|
| • Audio Multi- | • Video Multi- | • Digital Audio | • Digital Video |
| Media File | Media File | File Sharing | File Sharing |
| Sharing | Sharing | | |

The process is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 shows an overview of how a User accesses the system through the Internet.

FIG. 2 shows an overview of peer-to-peer processing.

FIG. 3 shows a representative user computer system that is connected to the network.

FIG. 4 shows a diagram representing agents that may be stored on the client computer systems to enable those systems to utilize and contribute to the network in accordance with the invention.

FIG. 5 shows the process on the current invention.

FIG. 6 shows how the digital acknowledgement trigger is attached to the file.

FIG. 7 shows how a file is transferred to a requesting User

### DESCRIPTION OF THE PREFERRED EMBODIMENT

The current invention process, the digital acknowledgement trigger, when created by software that makes the digital acknowledgement trigger work and activate, creates and defines that process which is needed to regulate the current infrastructure of P2P or file sharing networks, infrastructures or computer systems and computer networks overall, where individuals that are sharing information and content directly can now be tracked and used by way of computer programs work in tandem to regulate and track the actual users. It is a self running application that is also updated by a “individual” user who updates the software, which includes logic that make digital acknowledgement trigger “work and activate”, for centralized development, uniformity and would to the integrity of those same files that are stored and shared on the above mentioned servers and networks.

The most prevalent use of peer-to-peer networking is the trading of music across the Internet. Systems such as Napster have been developed specifically to foster that purpose. However, the invention is not limited in its capabilities to publish particular types of content, enabling users to publish and share any form of content across the network. As will be described below, publishing and retrieval of content across the network is accomplished anonymously. Further, conventional systems suffer from inherent disadvantages, some of which were described above, which the present invention purports to solve.

The invention provides a stable, reliable and scalable system for publishing and downloading content. Subscribers contribute resources to the network community by performing one or more services (for instance, storing blocks of data or hosting a tracking or relay service), in return for some type of payment (such as viewing an advertisement) that they can use to browse and download available content within the network, or otherwise transact with the network.

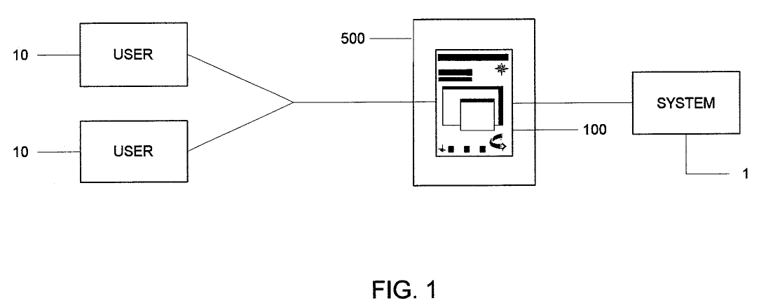

FIG. 1 illustrates a functional diagram of a computer network for World Wide Web 500 access to the system 1 from a plurality of Users 10 to the System Web Site 100 Accessing the System Web Site 100 can be accomplished directly through a communication means such as a local Internet Service Provider, often referred to as ISPs, or through an on-line service provider like CompuServe, Prodigy, or American Online.

The Users 10 contact the System Web site 100 using an informational processing system capable of running an HTML compliant Web browser such as Microsoft's Internet Explorer, Netscape Navigator, Lynx or Mosaic. A typical system that is used is a personal computer with an operating system such as Windows 95, 98 or ME or Linus, running a Web browser. The exact hardware configuration of computer used by the Users 10, the brand of operating system or the brand of Web browser configuration is unimportant to understand this present invention. Those skilled in the art can conclude that any HTML (Hyper Text Markup Language) compatible Web browser is within the true spirit of this invention and the scope of the claims.

In a traditional client-server distributed system, application software is usually split between server tasks and client tasks. A client system typically transmits a request to the server and the server responds accordingly. A part of the system that prepares or exchanges information on behalf of a server or a client is known as an agent. In a peer-to-peer system, each agent performs both server and client roles.

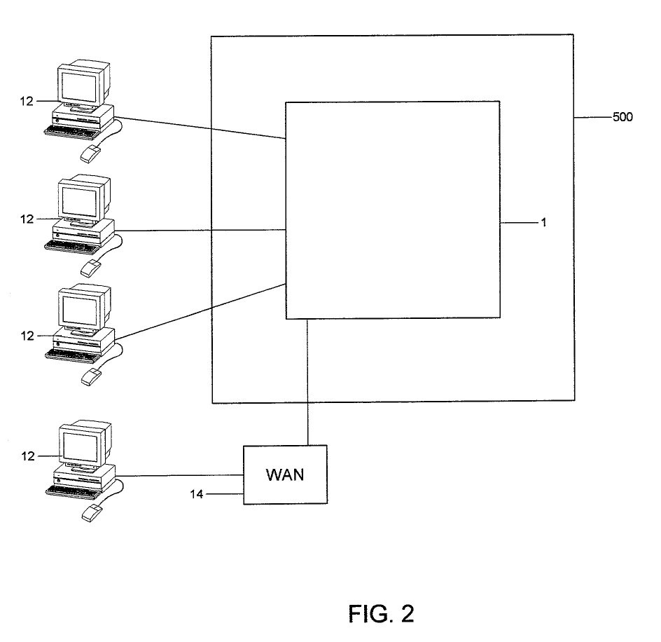

FIG. 2 is a diagram illustrating a peer-to-peer network in accordance with the invention. The system 1 may include a plurality of clients 12 connected in a peer-to-peer fashion across a wide area network (WAN) 14, such as the Internet, or more particularly, the World Wide Web. The User 10 may contain one or more pieces of software code 16 (agents) that may be stored on these machines and may be executed by a respective microprocessor 18 in order to operate as the invention. The Internet 500 permits the machines 12, when accessed by other machines 12 in the network 14, to communicate with each other in order to serve or host various requests or operations and to otherwise interact with each other.

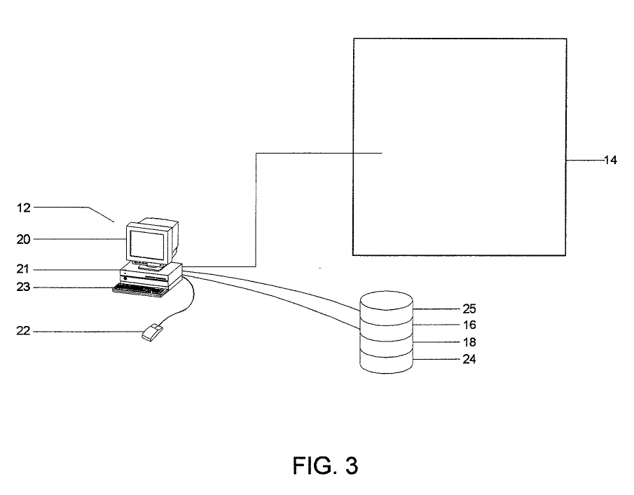

FIG. 3 is a diagram illustrating a representative client computer system 12 that is connected to the network 14 as shown in FIG. 2. Representative client computer systems 12 may include a display device 20, a chassis 21, and one or more user input devices, such as a mouse 22 and a keyboard 23. The chassis 21 may house a permanent storage system 24, such as a hard disk drive, optical disk drive, tape drive, or the like, which may store one or more software applications such as a web browser application 25, and one or more agents 16. The client computer system 12 may have a memory 26 resident therein and the software application(s) from the disk 24 may be transferred to the memory 26 to be executed by a CPU 18 in the computer system 12. The browser application 25 may be configured to connect the client computer system 12 with other machines 12 in the network 14 and receive graphical information (i.e., web pages) that may be displayed on the display device 20 to a user The browser application 25 may also permit the client computer systems 12 to interact with the other machines 12 in order to serve or host requests and operations in accordance with the invention.

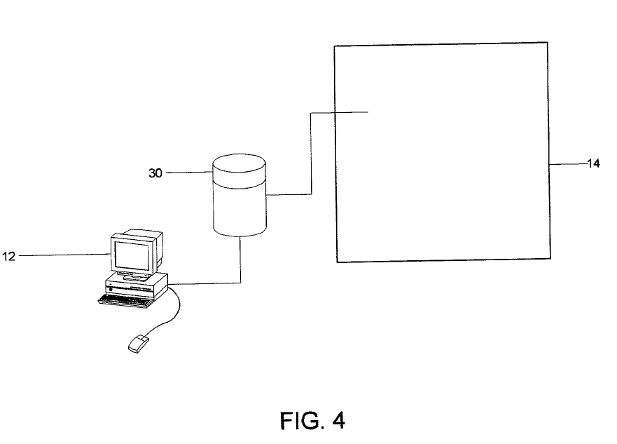

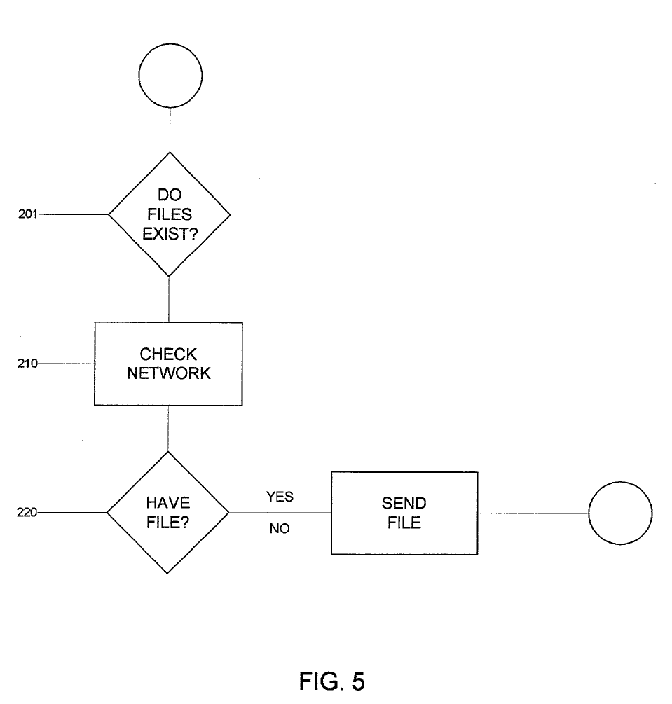

FIG. 4 is a diagram representing software components 16 that may be stored on the client computer systems 12 to enable those systems 12 to utilize and contribute to the network 14 in accordance with the invention. The client computer systems 12 may include a first software module 30 (i.e., a client agent) that is operable to enable these machines 12 to access the network 14 and be capable of consuming system resources provided by other systems 12 connected to the network 14. A user may download and install the client agent 30 from the Internet using techniques that are well known in the art, or may purchase, or otherwise obtain the client agent and directly install the client agent 30 onto the computer system 12. As shown in FIG. 5, in order for the digital acknowledgement trigger and invention to work, a P2P audio and video network, for example, would use the software, which would be used by the “end-user” of network to operate the P2Pzer so it works as such:

A user/computer “user” asks a “computer or network related computer or server” if an audio/video/digital art file exists on that particular computer or network related computer or server 201.

Every computer or network server or device which is “hooked” up or hooked into that same particular computer or network related computer or server mentioned in node 201 above, responds with a YES or a NO 210.

Every computer or network server or device which is “hooked” up or hooked into that same particular computer or network related computer or server mentioned in Node 210 above that answers yes, then hooks up or hooks directly into the user/computer's computer or network related computer or server for download 220.

Each download has a unique Digital software trigger 125, or “digital acknowledgement trigger” which is software originated. This trigger is induced by the end user of that particular computer or network related computer or server mentioned in node 210. Each tag is unique based upon the source IP address and file name requested for download, as well as invisible to the user, and with each user the “software trigger”, or “digital acknowledgement trigger” 125 is activated at the time the Digital File is used or opened without damaging the original file for which the download file was “shared”.

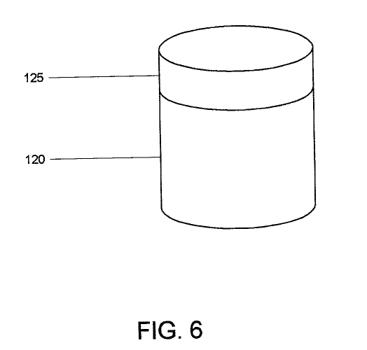

FIG. 6 shows the digital acknowledgement trigger 125 being attached to the downloaded file 120. The digital acknowledgement trigger 125 is unique for each download.

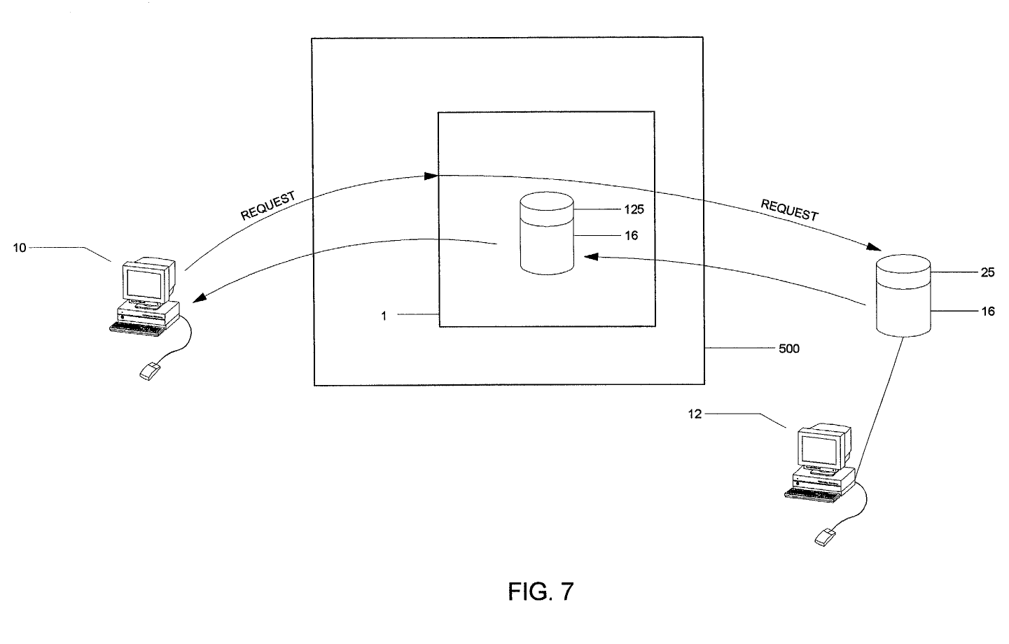

FIG. 7 shows the process in which the requested file is transferred. The user 10 makes the request to the system 1. The system 1 then makes a request to the other clients 12. If one of the other clients 12 has the requested file, the file 120 is uploaded to the system 1. The system 1 attaches the digital acknowledgement trigger 125 to the uploaded file 120. The file 120 is then downloaded from the system 1 to the User 10.

Operation

Businesses and corporations will use license software which includes the logic that includes the digital acknowledgement trigger 125. This produces the protected process which ensures that one's P2P or “file sharing” business can enter “commercial” status legally while keeping all parties that have a “vested” interest in a particular file “happy.”Businesses and corporations will use software induced algorithms to embed the software trigger, or “digital acknowledgement trigger 120” in all respective “to be downloaded or shared” files that are shared within one's respective business or consumer communities that are “open” for access and download.

When the user's computer 12 download is complete, and the file now also originates from the computer or network related computer or servers to which the download was delivered, that user opens or uses the file. The software trigger, or “digital acknowledgement trigger 120 activates the process for which the invention is invented

When the user's computer 12 opens the “file”, the system 1 then does:

a—Provides the originating file owner, or named entity to determined, the following information: id's the user/computer 10 where the file is opened, the date, and how often the file is opener by that user, and sends and/or routes information and/or payments directly to the parties involved in a normal P2P or file sharing networking environment which are: The intellectual property owner, the licensee who licenses the intellectual properties, and the networks, internet service providers or presence providers that host or provide for the actual originating file download that is shared by end users of that particular file.

Thus, the software induced process is capable of sending the software trigger, or “digital acknowledgement trigger 125” to files before download based on the user/computer's preferences.

b—After preferences are togged, the software trigger, or “digital acknowledgement trigger 125” allows for a process in which commercial advertisement can also be assigned before “delivery or download” based on the “preferences” that will open before the file is downloaded by the user/computer 10 and serves its purpose. In this case, the end user of the computer or network related computer would download the software trigger, or “digital acknowledgement trigger 125” equipped file, and would listen, read or view a commercial before the actual file is “breeched”, and the software trigger, or “digital acknowledgement trigger 125” activates and reports. This process essentially works for all downloaded and shared Internet based, network based, and computer based multi-media materials. The software trigger or “digital acknowledgement trigger 120” then reports the information back to the originating licensee or owner of the file that is “shared as viewed above.”

c—This allows for property owners and parties with “interest” a particular file, as viewed above, to approach advertisers or partners for commercialism of the P2P networking or file sharing “process”. The software trigger, or “digital acknowledgement triggers smart technology” allows the commercial to be played only once, or many times, or changed completely (or on schedule—monthly, weekly) and allows for the software trigger, or “digital acknowledgement trigger 125” to re-activate itself when another user downloads and/or uses the file This process can also include the capability to allow the users 10 to choose which advertisements or types of advertisement they wish to view.

d—Invention allows for “file owners” or entities that share files to program the files to:

1—play or send out message to end-user

2—integrate or remove commercials or images/data or other means of “pushing a message”

3—reset its commercial programming after a specified period of time

4—change produce advertisement/properties in and/or without the need for additional programming.

5—“file owners” or entities that share files to program the files to report royalties for advertising fees, report number of downloads vs. actual opening of files, reports overall usage of a file's life span, as viewed above.

If the user of the computer or network related computer or servers decides to send that file to another entity or computer network, person or entity or computer or network server, The software trigger, or “digital acknowledgement trigger 125” embedment will, again, re-activate and attaches itself to the file and operates steps #1 through #2, as seen above, and consequently step, #3.

In summary, the software trigger, or “digital acknowledgement trigger” process invention allows for computers and programs to work together to provide steps needed for this “process” of tracking and regulating “process” of file sharing over computer electronic devices, server, wireless or private networks. Therefore this invention, the software trigger, or “digital acknowledgement trigger 125” provides the following solutions:

Costly and timely legal disputes that are taking place in an “un-regulated” “process” where computer files are shared between networks, other computer devices and people. Infringements will now be limited in P2P and “file sharing” environments due to the tracking and licensing of Intellectual properties or owned files. The protected process helps protect companies that own and deliver P2P type networks to the commercial and consumer markets worldwide.

Allows for all parties teat have an owned or licensed interest in the particular “file shared” to track all end user destinations for determination of royalty payments, business development or however the entity that owns “the shared file” deems fit. “PARTIES” that have an interest in the “shared file” include, but are not limited to:

a—The originating server where “the file shared”. In this case, the owner of the server, computer or network.

b—The person, network, computer, electronic device, or server requesting the “shared file”.

c—The person, network, computer, electronic device, or server opening the “shared file”.

d—The person, network, computer, electronic device or server that shares the opened “shared file”.

Allows for the continuation of “free downloads” by consumers.

Controls the overall distribution of files between computers, servers, network servers and unknown entities.

Provides for legal and market commercialization structure and demeanor or methodology for P2P and “file sharing” networks.

Some of these problems with digital information protection systems may be overcome by providing a mechanism which allows a content provider to encrypt digital information without requiring either a hardware or platform manufacturer or a content consumer to provide support for the specific form of corresponding decryption. This mechanism can be provided in a manner which allows the digital information to be copied easily for back-up purposes and to be transferred easily for distribution, but which should not permit copying of the digital information in decrypted form. In particular, the encrypted digital information is stored as an executable computer program which includes a decryption program that decrypts the encrypted information to provide the desired digital information upon successful completion of an authorization procedure by the user. In combination with other mechanisms that track distribution, enforce royalty payments and control access to decryption keys, the present invention provides an improved method for identifying and detecting sources of unauthorized copies. Suitable authorization procedures also enable the digital information to be distributed for a limited number of uses and/or users, thus enabling per-use fees to be charged for the digital information.

Alternative Embodiments

The system 1, in which a User 1 cannot use a file unless it has the software on the Users computer 12 to recognize the digital acknowledgement trigger 125. If digital acknowledgement trigger 125 does not see the software, the file will not open. In the preferred embodiment, the software will provide the User 10 with a link so they can click on it, or a windows box link prompt, sending them to the web site 100.

Another method is to use a unique file format, such as MMT for MP3 files that contain and use the digital acknowledgement trigger 120 to run.

With the emerging markets of wireless, itv, etc., there are also new emerging network platforms that can be developed around a P2P or file sharing network oriented community. The file sharing networks we mention, or P2P file sharing network infrastructure platforms, are currently being designed for the wireless internet, interactive television

The current invention and process works seamlessly, with any file opener, browser, media player that is in existence within these emerging industries. The digital acknowledgement trigger 120 works with, and is not limited to any of the below file sharing industries:

1—Audio Multi-Media File Sharing, (includes mp3, wav, digital art)

2—Video Multi-Media File Sharing

3—Digital Audio File Sharing

4—Digital Video File Sharing

5—Wireless file streaming, sharing, transferring etc.

6—Digital Art, Protected Arts, works.

An entity that regulates originates or owns a P2P or file sharing network infrastructure allows public access to files on their respective servers and/or web portals, via the Internet. The public/consumer then:

Can be provided free access of the digital audio/video/digital art files via “free” and/or “paid” membership or subscription.

Once registered, or not requiring registration, the end user and or consumer downloads and or plays files which originate from that respective entities business model.

The respective entities can then monitor downloads, statistics, trends, demographics etc

The files initiate the software trigger, or “digital acknowledgement trigger 125” which is embedded within a file type. Each corporation or company will have its own unique “brand”, the software trigger, or “digital acknowledgement trigger 125” embedded in the file and or files. When the public/user 10 downloads the file or data, the data is sent to all parties with “interest” for processing

While the file, which is invention induced with the software trigger, or “digital acknowledgement trigger 125”, is sent to the servers which originate the “file download or transfer”, an advertising company is matched to the MP3 on route to end user. The invention induced software trigger, or “digital acknowledgement trigger 125 will then determine which advertisers, if any, have partnered with specific digital audio, video or data file being sent to user. The invention induced the software trigger, or “digital acknowledgement trigger 125” will send the commercials out based on the tag received to the end user simultaneously with the MP3 download.

For example:

Specific advertisers are partnered with specific corporations MP3's

Example Sony Music owns Madonna and the partnership agreement is with Pepsi Cola

The end user will receive the Madonna MP3 and only the Pepsi commercial.

The end users' MP3 or video player or file reader will assemble the “digital audio or video” file and the commercial together. Once the commercial is played, the software trigger, or “digital acknowledgement trigger” can be reset or removed. The end user will only hear the commercial once per download of that specific song or video is played. If the song is shared or transferred to another computer or altered, the software trigger, or “digital acknowledgement trigger 125” will be re-initiated, and the process will repeat. Any modifications of the MP3 will be sent to MP3zer for data processing. The advertiser and file owner can decide if the commercials are:

always played, “infinite loop”, or without any option to remove the commercial

the software trigger, or “digital acknowledgement trigger” removed, rendered “inactive” after the file is used, but re-activated when shared or sent to another end user

allows for the automatic or predetermined “reset” after a predetermined time (monthly, weekly, etc.) which allows for The software trigger, or “digital acknowledgement trigger 125” tag to be changed to another product or advertiser updated to a new commercial from the same advertiser

Initially, the end user has options to play/use the MP3/data in a regular java enabled web browser The tag sets rates for advertisers based on:

A blanket license

per downloaded file

per artist to partner with

The invention produced digital acknowledgement trigger analyzes the data to determine the royalties owed and forwards payment to the respective owners, or organizations responsible. (ASCAP, SOCAN, RIAA, etc.) The solution in summary:

| | | |
|---|---|---|
| • Internet Music | • New Internet Top | • Timed released to |
| Industry Copyright | 10, 20, 50, 100 MP3 | other geographies (to |
| Infringements | Music Industry Charts | curb unauthorized |
| | and related popularity | foreign release ) until |
| | charting | the “proper launch |
| | | date” in a specific |
| | | geography |
| • Controlled | • User Statistics | • Royalty Tracking and |
| distribution of MP3's | | Payment |
| Free LEGAL MP3's | • Promote the file | • Prevent under aged |
| to the public | sharing and P2P | persons from accessing |
| | because it is legal. | protected media |
| | | (adult lyrical content in |
| | | songs and video) |

### CONCLUSION

The previously described version of the present invention has many advantages. The current invention is a method for peer-to-peer file transfers that is secure, quick, profitable, and legal The intent is to develop a better method for searching the Internet for specific information from a number of web sites that is accurate, quick, inexpensive, and easy to use, showing there is still room for improvement within the art.

The digital acknowledgement trigger solves the following problems that currently exist with P2P and file sharing networks:

Entities are Unable to track file downloads

Entities are Unable to protect intellectual downloads and usage

Entities are Unable to determine the amount of downloads and/or time the file has been “shared”

Entries are Unable to commercialize, profit.

Although the present invention has been described in considerable detail with reference to certain preferred versions thereof, other versions are possible. For example, it could be used with non-peer-to-peer processing, different file structures, different formatting or platforms. Therefore, the point and scope of the appended claims should not be limited to the description of the preferred versions contained herein.

That which is claimed is:

1. A distributed system for publishing and retrieving content in a network, comprising: a plurality of computer systems connected together in a peer-to-peer fashion; one or more software applications associated with the computer systems for allowing the computer systems to publish and retrieve content from the network by initiating peer-to-peer interactions across the network using a digital trigger acknowledgement.

2 The distributed system of claim 1, wherein the computer systems have characterized network resources that can be contributed to the network in return for viewing an advertisement.

3. The distributed system of claim 1, wherein the network resources include any of disk space, bandwidth, and CPU processing cycles.

4. The distributed system of claim 1, wherein the interactions are performed by the client-server applications.

5. The system of claim 1, wherein each interaction across the network involves a transaction cost.

6. The distributed system of claim 1, wherein the content can be retrieved in return for viewing an advertisement.

7 The distributed system of claim 1, wherein the content can be retrieved in return for an advertisement being viewed when using the content.

8. The distributed system of claim 1, wherein the content can be retrieved in return for an advertisement being viewed while retrieving the content from the network.

9. The distributed system of claim 1, wherein the parts of the network may be connected through a wireless connection

10. The distributed system of claim 1, wherein the system keeps track of the content.

11. A distributed system for publishing and retrieving content in a network, comprising: a plurality of computer systems connected together in a peer-to-peer fashion; one or more software applications associated with the computer systems for allowing the computer systems to publish and retrieve content from the network by initiating peer-to-peer interactions across the network using a digital trigger acknowledgement.

12. The distributed system of claim 11, wherein the computer systems have characterized network resources that can be contributed to the network in return for viewing an advertisement.

13. The distributed system of claim 11, wherein the network resources include any of disk space, bandwidth, and CPU processing cycles.

14. The distributed system of claim 11, wherein the interactions are performed by the client-server applications.

15. The system of claim 11, wherein each interaction across the network involves a transaction cost.

16. The distributed system of claim 11, wherein the content can be retrieved in return for viewing an advertisement.

17 The distributed system of claim 11, wherein the content can be retrieved in return for an advertisement being viewed when using the content.

18 The distributed system of claim 11, wherein the content can be retrieved in return for an advertisement being viewed while retrieving the content from the network.

19. The distributed system of claim 11, wherein the parts of the network may be connected through a wireless connection.

20. The distributed system of claim 11, wherein the system keeps track of the content.
